(19) United States
(12) Patent Application Publication
(10) Pub. No.: US 2020/0128599 A1
(43) Pub. Date: Apr. 23, 2020

(54) DATA TRANSMISSION METHOD, TERMINAL DEVICE, AND NETWORK DEVICE

(71) Applicant: GUANGDONG OPPO MOBILE TELECOMMUNICATIONS CORP., LTD., Dongguan, Guangdong (CN)

(72) Inventor: Hai TANG, Dongguan, Guangdong (CN)

(21) Appl. No.: 16/621,232

(22) PCT Filed: Jun. 16, 2017
(86) PCT No.: PCT/CN2017/088688

§ 371 Date: Dec. 10, 2019

(51) Int. Cl. H04W 76/15; H04W 72/12

(52) U.S. Cl. CPC H04W 76/15; H04W 72/1268; H04W 72/1289

(57) ABSTRACT

A method for transmitting data, a terminal device and a network device are provided. The method includes: a terminal device receives first indication information sent by a network device, wherein the first indication information is used for indicating whether data duplication and transmission function is enabled for each Radio Bearer (RB) in at least one RB; and the terminal device sends data to the network device according to the first indication information.

### CROSS-REFERENCE TO RELATED APPLICATION(S)

This application is a 371 application of International Application No. PCT/CN2017/088688, filed on Jun. 16, 2017, the entire disclosure of which is hereby incorporated by reference.

### TECHNICAL FIELD

Implementations of the present application relate to the field of communication, and more particularly, relate to a method for transmitting data, a terminal device, and a network device.

### BACKGROUND

Under a scenario of carrier aggregation, Packet Data Convergence Protocol (PDCP) can support a data duplication function, i.e., a PDCP Protocol Data Unit (PDU) is duplicated into two duplications (possibly more duplications) to improve reliability of data transmission. In the prior art, a default state of a PDCP data duplication and transmission function is used for data transmission, which is not flexible enough.

### SUMMARY

In view of this, implementations of the present application provide a method for transmitting data, a terminal device and a network device.

In a first aspect, a method for transmitting data is provided, and the method includes: receiving, by a terminal device, first indication information sent by a network device, wherein the first indication information is used for indicating whether a data duplication and transmission function is enabled for each Radio Bearer (RB) in at least one RB; and sending, by the terminal device, data to the network device according to the first indication information.

The network device indicates for which RBs the data duplication and transmission function is enabled or disenabled to the terminal device, which is beneficial to improving flexibility of data transmission.

Optionally, solutions of implementations of the present application may be applied to a scenario of uplink data transmission, or may also be applied to a scenario of Device to Device (D2D) communication.

Radio Bearer (RB) is a general name of a series of protocol entities and configurations allocated by a network device to a user equipment, and includes a PDCP protocol entity, a Radio Link Control (RLC) protocol entity, a Media Access Control (MAC) protocol entity, and a series of resources allocated for a Physical Layer (PHY). The RB includes a Signaling Radio Bearer (SRB) and a Data Radio Bearer (DRB). The SRB is a channel through which signaling messages of a system are actually transmitted, and the DRB is a channel through which user data are actually transmitted.

That the data duplication and transmission function is enabled refers to that a PDCP entity corresponding to a certain RB duplicates a PDCP PDU into multiple duplications, and transmits the multiple duplications on multiple RLC entities respectively. However, that the data duplication and transmission function is disenabled refers to that the data duplication and transmission function is not used, i.e., a PDCP PDU transmitted by a PDCP entity corresponding to certain an RB is not duplicated data, and may be transmitted once in one RLC entity, or a PDCP PDU may be divided into multiple portions for transmission in multiple RLC entities.

Optionally, the PDCP PDU here may be some services with a high reliability requirement for data transmission. That is, when PDCP PDUs of these services need to be transmitted, it needs to be determined whether a data duplication and transmission function needs to be enabled for a certain RB. For other PDCP PDUs that do not have a high requirement for data transmission, whether to enable the data duplication and transmission function for a certain RB may not need to be determined, and the data duplication and transmission function of the RB is directly disenabled.

In a possible implementation, receiving, by the terminal device, the first indication information sent by the network device, includes: receiving, by the terminal device, the first indication information sent by the network device through a Media Access Control (MAC) Control Element (CE).

In a possible implementation, the first indication information carries an identification of the each RB, wherein the identification of the each RB is used for indicating that the duplication and transmission function is enabled for a corresponding RB, or the identification of the each RB is used for indicating that the data duplication and transmission function is stopped to be used for a corresponding RB.

Optionally, the network device and the terminal device may pre-agree that an identification of an RB sent by the network device to the terminal device indicates that the RB may use a data duplication and transmission function or an identification of an RB sent by the network device to the terminal device indicates that the RB may not use a data duplication and transmission function.

In a possible implementation, the first indication information is a bit map, and each bit in the bit map corresponds one-to-one with the each RB, and a value of each bit indicates whether the data duplication and transmission function is enabled for a corresponding RB.

Optionally, one bit in the first indication information may be used for indicating whether a data duplication and transmission function is enabled for a certain RB. The network device may also multiplex one bit in the first indication information, that is, the bit is originally included in the indication information for indicating other information, and the bit may also indicate whether the data duplication and transmission function is enabled for the RB at the same time.

In a possible implementation, sending, by the terminal device, the data to the network device according to the first indication information, includes: determining, by the terminal device, that the data duplication and transmission function is enabled for a first RB in the at least one RB according to the first indication information; and sending, by the terminal device, duplicated data to the network device through multiple logical channels corresponding to a Packet Data Convergence Protocol (PDCP) entity corresponding to the first RB.

Optionally, if a previous state of the RB is stopping using the data duplication and transmission function, that is, duplicated data had been transmitted on the RB, but data transmitted on the RB last time is non-duplicated data, then the network may have configured for the RB one PDCP entity corresponding to multiple RLC entities, but in the last transmission, the terminal device only adopts a certain RLC entity in the multiple RLC entities to transmit non-duplicated data or a part of the multiple RLC entities to transmit non-duplicated data. And if the network device indicates that the data duplication and transmission function is enabled for the RB, then the terminal device may directly use the multiple RLC entities to transmit the duplicated data or directly use a part of the multiple RLC entities to transmit the duplicated data.

In a possible implementation, before the terminal device sends the duplicated data to the network device through the multiple logical channels corresponding to the Packet Data Convergence Protocol (PDCP) entity corresponding to the first RB, the method further includes: when the PDCP entity corresponds to only one logical channel, receiving, by the terminal device, second indication information, wherein the second indication information is used for indicating at least one other logical channel used for transmitting the duplicated data.

In a possible implementation, sending, by the terminal device, the data to the network device according to the first indication information, includes: determining, by the terminal device, that the data duplication and transmission function is stopped to be used for a first RB in the at least one RB according to the first indication information; and sending, by the terminal device, non-duplicated data to the network device through a logical channel corresponding to a PDCP entity corresponding to the first RB.

In a possible implementation, sending, by the terminal device, the non-duplicated data to the network device through the logical channel corresponding to the PDCP entity corresponding to the first RB, includes: when the PDCP entity corresponds to multiple logical channels, receiving, by the terminal device, second indication information sent by the network device, wherein the second indication information is used for indicating a first logical channel used for transmitting data in the multiple logical channels; and sending, by the terminal device, the non-duplicated data to the network device through the first logical channel.

Optionally, the second indication information may be an identification of a logical channel corresponding to a certain RLC entity or identifications of logical channels of certain RLC entities. Or, explicit indication mode may be used for indicating that a certain RLC entity or certain RLC entities may be used for transmitting non-duplicated data, and which RLC entity or RLC entities may stop transmitting data.

In a possible implementation, sending, by the terminal device, the non-duplicated data to the network device through the logical channel corresponding to the PDCP entity corresponding to the first RB, includes: when the PDCP entity corresponds to multiple logical channels, receiving, by the terminal device, second indication information sent by the network device, wherein the second indication information is used for indicating a first logical channel not used for transmitting dada in the multiple logical channels; and sending, by the terminal device, the non-duplicated data to the network device through a second logical channel in two logical channels.

In a second aspect, a method for transmitting data is provided, and the method includes: sending, by a network device, first indication information to a terminal device, wherein the first indication information is used for indicating whether a data duplication and transmission function is enabled for each Radio Bearer (RB) in at least one RB; and receiving, by the network device, data sent by the terminal device through the at least one RB.

In a possible implementation, sending, by the network device, the first indication information to the terminal device, includes: sending, by the network device, the first indication information to the terminal device through a Medium Access Control (MAC) Control Element (CE).

In a possible implementation, the first indication information carries an identification of the each RB, wherein the identification of the each RB is used for indicating that the data duplication and transmission function is enabled for a corresponding RB, or the identification of each RB is used for indicating that the data duplication and transmission function is stopped to be used for a corresponding RB.

In a possible implementation, the first indication information is a bit map, wherein each bit in the bit map corresponds one-to-one with the each RB, and a value of the each bit indicates whether the data duplication and transmission function is enabled for a corresponding RB.

In a possible implementation, the first indication information is used for indicating that the data duplication and transmission function is enabled for a first RB in the at least one RB. Receiving, by the network device, the data sent by the terminal device through the at least one RB, includes: receiving, by the network device, duplicated data sent by the terminal device through multiple logical channels corresponding to a Packet Data Convergence Protocol (PDCP) entity corresponding to the first RB.

In a possible implementation, the method further includes: when the PDCP entity corresponds to only one logical channel, sending, by the network device, second indication information to the terminal device, wherein the second indication information is used for indicating at least one other logical channel used for transmitting the duplicated data.

In a possible implementation, the first indication information is used for indicating that the data duplication and transmission function is stopped to be used for a first RB in the at least one RB to stop. Receiving, by the network device, the data sent by the terminal device through the at least one RB, includes: receiving, by the network device, non-duplicated data sent by the terminal device through a logical channel corresponding to a PDCP entity corresponding to the first RB.

In a possible implementation, the method further includes: when the PDCP entity corresponds to multiple logical channels, sending, by the network device, second indication information to the terminal device, wherein the second indication information is used for indicating a first logical channel used for transmitting data in the multiple logical channels or a second logical channel not used for transmitting data in the multiple logical channels.

In a possible implementation, the at least one RB includes a Data Radio Bearer (DRB) and/or a Signaling Radio Bearer (SRB).

In a third aspect, a terminal device is provided, which is used for performing the method in the above first aspect or any possible implementation mode of the first aspect. Specifically, the terminal device includes units for executing the method of above first aspect or the method in any possible implementation of the above first aspect.

In a fourth aspect, a network device is provided, which is used for performing the method in the above second aspect or any possible implementation of the second aspect. Specifically, the network device includes units used for performing the method in the second aspect or any possible implementation of the above second aspect.

In a fifth aspect, a terminal device is provided. The terminal device includes a memory, a processor, an input interface, and an output interface. The memory, the processor, the input interface and the output interface are connected through a bus system. The memory is used for storing instructions, and the processor is used for executing the instructions stored in the memory to perform the method in the first aspect or any possible implementation of the above first aspect.

In a sixth aspect, a network device is provided. The network device includes a memory, a processor, an input interface, and an output interface. The memory, the processor, the input interface and the output interface are connected through a bus system. The memory is used for storing instructions, and the processor is used for executing the instructions stored in the memory to perform the method in the second aspect or any possible implementation of the above second aspect.

In a seventh aspect, a computer storage medium is provided, which is used for storing computer software instructions for executing the method of the above first aspect or any possible implementation of the first aspect, or the method of the above second aspect or any possible implementation of the second aspect, wherein, the computer software instructions contain programs designed for executing the above aspects.

In an eighth aspect, a computer program product including instructions is provided, wherein, when the product is run on a computer, the computer is caused to execute the method of the above first aspect or any one of optional implementations of the first aspect, or the method of the above second aspect or any one of optional implementations of the second aspect.

These aspects and other aspects of the present application will be more easily understood from following description of implementations.

### BRIEF DESCRIPTION OF DRAWINGS

FIG. 1 is a schematic diagram of an application scenario according to an implementation of the present application.

FIG. 2 shows a schematic diagram of protocol architecture of data duplication and transmission under a scenario of carrier aggregation.

FIG. 3 is a schematic block diagram of a method for transmitting data according to an implementation of the present application.

FIG. 4 is another schematic block diagram of a method for transmitting data according to an implementation of the present application.

FIG. 5 is a schematic block diagram of a terminal device for transmitting data according to an implementation of the present application.

FIG. 6 is a schematic block diagram of a network device for transmitting data according to an implementation of the present application.

FIG. 7 is another schematic block diagram of a terminal device for transmitting data according to an implementation of the present application.

FIG. 8 is another schematic block diagram of a network device for transmitting data according to an implementation of the present application.

### DETAILED DESCRIPTION

Technical solutions in implementations of the present application will be clearly and completely described below with reference to the drawings in the implementations of the present application.

It should be understood that the technical solutions of the implementations of the present application may be applied to various communication systems, such as, a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, a LTE Frequency Division Duplex (FDD) system, a LTE Time Division Duplex (TDD) system, a Universal Mobile Telecommunication System (UMTS) system, a Worldwide Interoperability for Microwave Access (WiMAX) communication system, a New Radio (NR) System, or a future 5G system, etc.

Specifically, the technical solutions of the implementations of the present application may be applied to various communication systems based on non-orthogonal multiple access technologies, such as a Sparse Code Multiple Access (SCMA) system, and a Low Density Signature (LDS) system, etc. The SCMA system and the LDS system may also be referred to as other names in the field of communication. Further, the technical solutions of the implementations of the present application may be applied to a multi-carrier transmission system employing a non-orthogonal multiple access technology, such as an Orthogonal Frequency Division Multiplexing (OFDM) system employing the non-orthogonal multiple access technology, a Filter Bank Multi-Carrier (FBMC) system, a Generalized Frequency Division Multiplexing (GFDM) system, a Filtered OFDM (F-OFDM) system, or the like.

A terminal device in the implementations of the present application may be referred to a user equipment (UE), an access terminal, a subscriber unit, a subscriber station, a mobile station, a mobile platform, a remote station, a remote terminal, a mobile device, a user terminal, a terminal, a wireless communication device, a user agent or a user apparatus. An access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device or another processing device connected to a wireless modem, an on-board device, a wearable device, a terminal device in a future 5G network, or a terminal device in a future evolved Public Land Mobile Network (PLMN), etc., which is not restricted in the implementations of the present application.

A network device in the implementations of the present application may be a device for communicating with a terminal device. The network device may be a Base Transceiver Station (BTS) in GSM or CDMA, a NodeB (NB) in a WCDMA system, or may be an Evolutional NodeB (eNB or eNodeB) in an LTE system, or may be a wireless controller under a scenario of a Cloud Radio Access Network (CRAN), or the network device may be a relay station, an access point, an on-board device, a wearable device, a network device in a future 5G network or a network device in the future evolved PLMN, etc., which is not restricted in the implementations of the present application.

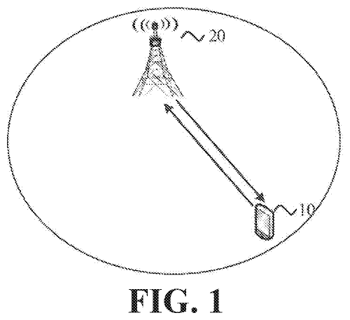

FIG. 1 is a schematic diagram of an application scenario according to an implementation of the present application. A communication system in FIG. 1 may include a terminal device 10 and a network device 20. The network device 20 is configured to provide communication services for the terminal device 10 and is connected to a core network. The terminal device 10 accesses the network by searching for a synchronization signal, or a broadcast signal, etc., transmitted by the network device 20 to communicate with a network. Arrows shown in FIG. 1 may represent uplink/downlink transmission through cellular links between the terminal device 10 and the network device 20.

Under a scenario of carrier aggregation, the PDCP may support a data duplication function, i.e., the data duplication function of the PDCP is utilized, so that duplicated data corresponds to two or more logical channels, and finally it ensures that multiple duplicated PDCP PDUs which are same can be transmitted on different aggregated carriers for the physical layer, thus frequency diversity gain is achieved to improve reliability of data transmission.

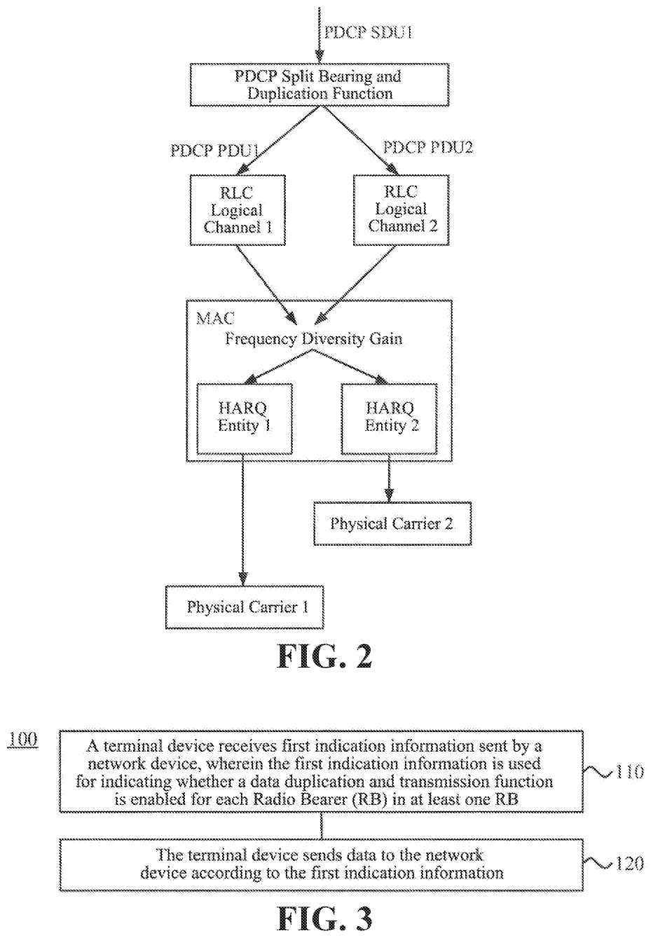

For ease of understanding, how to schedule duplicated data on different physical carriers will be briefly described below with reference to FIG. 2. As shown in FIG. 2, a PDCP layer has a split bearing and duplication function, and a data process of PDCP SDU1 is duplicated and encapsulated into PDCP PDU1 and PDCP PDU2. The PDCP PDU1 and the PDCP PDU2 have same contents, i.e., payloads and headers borne by the PDCP PDU1 and the PDCP PDU2 are the same. The PDCP PDU1 and the PDCP PDU2 are respectively mapped to different RLC entities, and the RLC entities place the PDCP PDU1 and the PDCP PDU2 on different logical channels (Logical Channel 1 and Logical Channel 2). After knowing which logical channels transmit duplicated data of a same PDCP PDU, the MAC transmits these duplicated data on different carriers through different Hybrid Automatic Repeat Request (HARQ) entities. For example, the duplicated data borne in the Logical Channel 1 is transmitted on Physical Carrier 1 through HARQ Entity 1, and the duplicated data borne in the Logical Channel 2 is transmitted on Physical Carrier 2 through HARQ Entity 2.

Although data duplication and transmission of the PDCP layer can effectively improve reliability of data transmission by utilizing diversity gain, how to flexibly use the data duplication and transmission function of the PDCP is a problem to be solved.

Those skilled in the art understand that an uplink PDCP data duplication function may be configured based on a Radio Bearer (RB), that is, different RBs may be configured to support data duplication and transmission of the PDCP or not be configured to support data duplication and transmission of the PDCP.

RB is a general name of a series of protocol entities and configurations allocated by a base station to a user equipment, and includes a PDCP protocol entity, a Radio Link Control (RLC) protocol entity, and a series of resources allocated for the MAC and PHY. An RB includes a SRB and a DRB. The SRB is a channel through which signaling messages of a system are actually transmitted, and the DRB is a channel through which user data are actually transmitted.

It should be understood that the terms “system” and “network” are often used interchangeably in this document. The term “and/or” in this document is merely an association relationship describing associated objects, indicating that there may be three relationships, for example, A and/or B may indicate three cases: A alone, A and B, and B alone. In addition, the symbol “/” in this document generally indicates that objects before and after the symbol “/” have an “or” relationship.

FIG. 3 is a schematic block diagram of a method 100 for transmitting data according to an implementation of the present application. As shown in FIG. 3, the method 100 includes acts S110 and S120.

In S110, a terminal device receives first indication information sent by a network device, wherein the first indication information is used for indicating whether a data duplication and transmission function is enabled for each Radio Bearer (RB) in at least one RB.

In S120, the terminal device sends data to the network device according to the first indication information.

Specifically, the network device may decide by itself whether a data duplication and transmission function needs to be enabled for a certain RB. For example, the network device may make the decision according to whether a current service has a reliability requirement for data transmission. If high reliability is required for data transmission, the network device may decide to adopt data duplication and transmission. The network device may also decide how many RBs are used and which RBs are used for transmission of duplicated data. And the network device may inform the terminal device of an identification of a selected RB, or the network device may inform the terminal device that whether each RB is used to transmit the duplicated data. After receiving the indication information sent by the network device, the terminal device may further send data to the network device according to the indication information. For example, if the indication information indicates that a certain RB is used for transmitting duplicated data, then the terminal device may use the RB to transmit the duplicated data to the network device. If the indication information indicates that a certain RB is used for transmitting non-duplicated data, then the terminal device may use the RB to transmit the non-duplicated data to the network device.

Therefore, in the method for transmitting data according to the implementation of the present application, data is send based on the indication of the network device, which is beneficial to improving flexibility of data transmission.

Optionally, in an implementation of the present application, receiving, by the terminal device, the first indication information sent by the network device, includes: the terminal device receives the first indication information sent by the network device through a Medium Access Control (MAC) Control Element (CE).

It should be understood that the first indication information proposed by the implementations of the present application may be borne in an MAC signaling, or the first indication information may be borne in a signaling of another layer, such as a PHY signaling, an RLC layer signaling, etc., which is not restricted in the implementations of the present application.

Optionally, in an implementation of the present application, the first indication information carries an identification of the each RB, wherein the identification of the each RB is used for indicating that the data duplication and transmission function is enabled for a corresponding RB, or the identification of the each RB is used for indicating that the data duplication and transmission function is stopped to be used for a corresponding RB.

Specifically, the network device and the terminal device may pre-agree that an identification of an RB sent by the network device to the terminal device indicates that the data duplication and transmission function may be used for the RB, or an identification of an RB sent by the network device to the terminal device indicates that the data duplication and transmission function may not be used for the RB. Then after determining on which RBs the data duplication and transmission function may be used or on which RBs the data duplication and transmission function may not be used, the network device may send identifications of these RBs to the terminal device. Then after receiving the identifications of the RBs, the terminal device knows on which RBs the data duplication and transmission function may be used and on which RBs the data duplication and transmission function may not be used according to the agreed rule and then the terminal device may use the corresponding RBs to send duplicated data or non-duplicated data.

Optionally, in an implementation of the present application, the first indication information is a bit map, wherein each bit in the bit map corresponds one-to-one with the each RB, and a value of the each bit indicates whether a data duplication and transmission function is enabled for a corresponding RB.

Specifically, the network device may also explicitly indicate whether a data duplication and transmission function is enabled for a certain RB. For example, the network device may pre-agree with the terminal device that 1 bit is used to indicate whether a data duplication and transmission function is enabled for a certain RB. For example, “1” indicates that a data duplication and transmission function is enabled for an RB, that is, the terminal device may use the RB to transmit duplicated data, and “0” indicates that a data duplication and transmission function is stopped to be used for an RB, that is, the terminal device may use the RB to transmit non-duplicated data. Then the network device may send indication information to the terminal device, and there is one bit in the indication information independently used for indicating whether a data duplication and transmission function is enabled for the RB. The network device may also multiplex one bit in the indication information, that is, the bit is originally included in the indication information to indicate other information, but the bit may indicate whether a data duplication and transmission function is enabled for the RB at the same time. Similarly, if the network device needs to explicitly indicate whether a data duplication and transmission function is enabled for multiple RBs, the network device may use a bit map and the number of bits in the bit map represents the number of RBs indicated by the network device to the terminal device, and each bit in the bit map is used for indicating whether a data duplication and transmission function is enabled for the RB represented by the each bit. For example, in general, the number of DRBs in wireless communication is up to 8, and a bit map of 8 bits may be used. The 8 DRBs may be mapped to the bit map in advance, that is, each bit in the bit map represents one DRB in the 8 DRBs, and the network device and the terminal device both know this mapping relationship in advance. Then, after the terminal device receives the bit map, the terminal device may check whether a data duplication and transmission function is enabled for a DRB represented by each bit according to the mapping relationship.

It should be understood that the above two indication modes are only schematic illustrations, and implementations of the present application are not restricted to them. Any mode for indicating whether a data duplication and transmission function is enabled for an RB is within the protection scope of implementations of the present application.

Optionally, in an implementation of the present application, sending, by the terminal device, the data to the network device according to the first indication information, includes: the terminal device determines that the data duplication and transmission function is enabled for a first RB in the at least one RB according to the first indication information; and the terminal device sends duplicated data to the network device through multiple logical channels corresponding to a Packet Data Convergence Protocol (PDCP) entity corresponding to the first RB.

If the network device indicates to the terminal device that a data duplication and transmission function is enabled for a certain RB, then the terminal device may use the RB to send duplicated data to the network device. Specifically, the terminal device needs to send the duplicated data to the network device through multiple RLC entities corresponding to the PDCP entity corresponding to the RB. One RLC entity may correspond to one logical channel. Taking FIG. 2 as an example, an entire data transmission path in FIG. 2 may be referred to as one DRB. In the figure, one DRB may include one PDCP entity and two RLC entities, and be mapped to different physical carriers through an MAC entity. If the network device indicates that a data duplication and transmission function is enabled for the DRB shown in FIG. 2, then the terminal device may directly duplicate a PDCP PDU at the PDCP entity into two duplications, and respectively place the two duplications on two RLC entities for transmission, and then the two PDUs may be placed on different physical carriers for transmission, thus frequency diversity gain is achieved to improve reliability of data transmission.

It should be understood that the above description uses an example that one PDCP entity corresponds to two RLC entities for transmission of duplicated data. In an implementation of the present application, multiple RLC entities may correspond to one PDCP entity. When duplicated data needs to be transmitted, a PDCP PDU may be directly duplicated into multiple duplications and placed on the multiple RLCs corresponding to the PDCP for transmission, which is not restricted in the implementations of the present application.

Optionally, if a previous state of the RB is stopping using the data duplication and transmission function, that is, duplicated data has been previously transmitted on the RB, but data transmitted on the RB last time is non-duplicated data, then the network may have configured for the RB one PDCP entity corresponding to multiple RLC entities, but in the last transmission, the terminal device adopts only a certain RLC entity in the multiple RLC entities to transmit the non-duplicated data or a part of the multiple entities to transmit the non-duplicated data. And if the network device indicates that the data duplication and transmission function is enabled for the RB, then the terminal device may directly use the multiple RLC entities to transmit duplicated data or directly used a part of the multiple RLC entities to transmit duplicated data.

Optionally, if a default state configured for an RB is stopping using a data duplication and transmission function, it can be understood that the RB has been used for transmitting non-duplicated data all the time. In this case, the network may have configured for the RB one PDCP corresponding to one RLC entity, then when the network device indicates a data duplication and transmission function is enabled for the RB, the terminal device needs to use at least one other RLC entity to send duplicated data to the network device in addition to using the one RLC entity corresponding to the PDCP. The other RLC entity to be used may be decided by the PDCP entity or may be indicated by the network device.

Optionally, in an implementation of the present application, before the terminal device sends the duplicated data to the network device through the multiple logical channels corresponding to the Packet Data Convergence Protocol (PDCP) entity corresponding to the first RB, the method further includes: when the PDCP entity only corresponds to one logical channel, the terminal device receives second indication information, wherein the second indication information is used for indicating at least one other logical channel used for transmitting the duplicated data.

Specifically, the second indication information may be an identification of a logical channel corresponding to a certain RLC entity or identifications of logical channels corresponding to certain RLC entities. In other words, the network device may agree in advance that as long as the terminal device receives identifications of certain logical channels, it may indicate that RLC entities corresponding to the logical channels may be associated with a PDCP of a certain RB. Or the network device may agree in advance that as long as the terminal device receives identifications of certain logical channels, it may indicate that an RLC entity corresponding to a logical channel other than the logical channels may be associated with a certain RLC entity.

Similarly, it may explicitly indicate that an RLC entity corresponding to a certain logical channel may be associated with a PDCP corresponding to a certain RB. Assuming that the terminal device may agree that “1” represents Logical Channel 0 and “0” represents Logical Channel 1, then after the terminal device receives the indication information related to a certain RB, the terminal device may know that an RLC entity corresponding to a certain logical channel may be associated with a PDCP entity corresponding to the RB.

Optionally, if a default state configured for an RB is stopping using a data duplication and transmission function, it may be understood that non-duplicated data has been transmitted on the RB all the time. In this case, the network may have configured for the RB one PDCP corresponding to multiple RLC entities. That is, the network may have let multiple RLC entities correspond to the PDCP entity corresponding to the RB, but the network does not use the multiple RLC entities to transmit duplicated data previously, and the network device transmits non-duplicated data previously. For example, the terminal device may use one RLC entity in the multiple RLC entities or the multiple RLC entities corresponding to the PDCP corresponding to the RB to transmit non-duplicated data. Then when the network device indicates that a data duplication and transmission function is enabled for the RB, the terminal device may directly use a part or all of the RLC entities in the multiple RLC entities to transmit the duplicated data.

It should be understood that if the terminal device uses a part of the RLC entities in the multiple RLC entities to transmit the duplicated data, the terminal device may decide by itself which RLC entities are used to transmit the duplicated data, or the network device may indicate which RLC entities are used to transmit the duplicated data.

It should be further understood that the indication of which RLC entities are used for transmitting duplicated data is similar as the above, and it may also be an identification or an explicit indication of a logical channel corresponding to the RLC entity sent to the terminal device.

Optionally, in an implementation of the present application, sending, by the terminal device, the data to the network device according to the first indication information, includes: the terminal device determines that the data duplication and transmission function is stopped to be used for the first RB in the at least one RB according to the first indication information; and the terminal device sends non-duplicated data to the network device through a logical channel corresponding to a PDCP entity corresponding to the first RB.

Specifically, if the network device indicates to the terminal device that the data duplication and transmission function is stopped to be used for a certain RB, that is, the RB is used by the terminal device to transmit duplicated data last time, then the PDCP entity corresponding to the RB corresponds to multiple RLC entities. After receiving the indication from the network device, the terminal device may use one or more RLC entities in the multiple RLC entities corresponding to the PDCP entity corresponding to the RB to transmit non-duplicated data.

Optionally, the terminal device may decide by itself which RLC entities in the multiple RLC entities to use for transmission of non-duplicated data based on a certain rule. The network device may also send an indication to the terminal device to indicate which RLC entities of the multiple RLC entities are used for transmission of non-duplicated data. The network device may also send an indication to the terminal device to indicate which RLC entities in the multiple RLC entities cannot transmit non-duplicated data, then the terminal device may use other RLC entities in the multiple RLC entities to transmit the non-duplicated data. The terminal device may release the RLC entities, in the multiple RLC entities, which are not used for transmitting non-duplicated data.

Optionally, the network device may carry the above first indication information and the above second indication information in one message, i.e., the above information indicating whether the data duplication and transmission function is enabled for an RB and the above information indicating a logical channel corresponding to another RLC entity. For example, a table may be used, each column of the table represents one RB, and each row of the table represents the first indication information or the second indication information. The details are shown in Table 1.

TABLE 1

| | | | | | | | |
|---|---|---|---|---|---|---|---|
| 0 | 1 | 0 | 0 | 0 | 1 | 1 | 0 |
| 0 | 0 | 0 | 0 | 0 | 0 | 1 | 0 |

As shown in Table 1, the network device and the terminal device may agree on a meaning of the table in advance, that is, what each row of the table represents, what each column of the table represents, and what each value of the table represents. For example, the first row in Table 1 indicates whether the data duplication and transmission function is enabled for each RB in 8 RBs. The second row in Table 1 indicates which logical channel is stopped to be used for each RB on which the data duplication and transmission function is stopped to be used in the 8 RBs. A same column in Table 1 indicates a same RB. In this table, when the data duplication and transmission function is enabled for an RB indicated by the first row, the value of the second row in this column may be ignored. Specifically, the above Table 1 indicates that the data duplication and transmission function is enabled for RB1, RB5, and RB6, while the data duplication and transmission function is stopped to be used for RB0, RB2, RB3, RB4, and RB7. And Logical Channel 0 is stopped for RB0, RB2, RB3, RB4, and RB7 (assuming that “0” in the first row represents stopping using the data duplication and transmission function, “1” in the first row represents the data duplication and transmission function is enabled, “0” in the second row represents Logical Channel 0, and “1” in the second row represents Logical Channel 1).

It should be understood that the above description takes two values “0” and “1” as examples, and a specific value of each bit in the second row may also be a value in a set, which should not be restricted to “0” and “1”. For example, “0” to “2” may respectively represent Logical Channels 0 to 2, which is not restricted in implementations of the present application, and the meaning represented by the above values is not restricted.

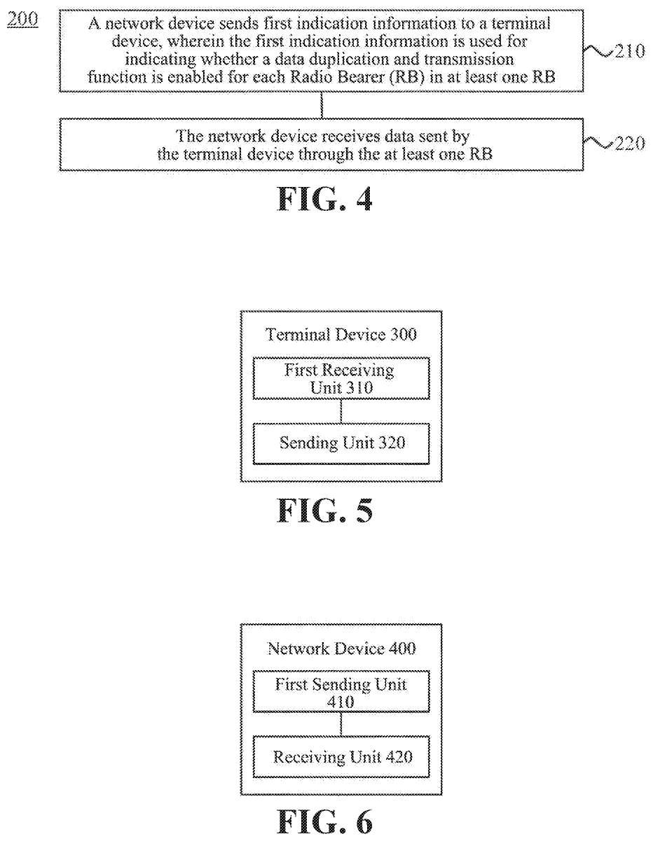

FIG. 4 is a schematic block diagram of a method 200 for transmitting data according to an implementation of the present application. As shown in FIG. 4, the method 200 includes acts S210 and S220.

In S210, a network device sends first indication information to the terminal device, wherein the first indication information is used for indicating whether a data duplication and transmission function is enabled for each Radio Bearer (RB) in at least one RB.

In S220, the network device receives data sent by the terminal device through the at least one RB.

Therefore, the method for transmitting data in the implementation of the present application is beneficial to improving flexibility of data transmission.

Optionally, in an implementation of the present application, sending, by the network device, the first indication information to the terminal device, includes: the network device sends the first indication information to the terminal device through a Media Access Control (MAC) Control Element (CE).

Optionally, in an implementation of the present application, the first indication information carries an identification of the each RB, wherein the identification of the each RB is used for indicating that the data duplication and transmission function is enabled for a corresponding RB, or the identification of the each RB is used for indicating that the data duplication and transmission function is stopped to be used for a corresponding RB.

Optionally, in an implementation of the present application, the first indication information is a bit map, wherein each bit in the bit map corresponds one-to-one with the each RB, and a value of the each bit indicates whether a data duplication and transmission function is enabled for a corresponding RB.

Optionally, in an implementation of the present application, the first indication information is used for indicating the data duplication and transmission function is enabled for a first RB in the at least one RB. The network device receives the data sent by the terminal device through the at least one RB, includes: the network device receives duplicated data sent by the terminal device through multiple logical channels corresponding to a Packet Data Convergence Protocol (PDCP) entity corresponding to the first RB.

Optionally, in an implementation of the present application, the method further includes: when the PDCP entity only corresponds to one logical channel, the network device sends second indication information to the terminal device, wherein the second indication information is used for indicating at least one other logical channel used for transmitting duplicated data.

Optionally, in an implementation of the present application, the first indication information is used for indicating that the data duplication and transmission function is stopped to be used for a first RB in the at least one RB. Receiving, by the network device, the data sent by the terminal device through the at least one RB, includes: the network device receives non-duplicated data sent by the terminal device through a logical channel corresponding to a PDCP entity corresponding to the first RB.

Optionally, in an implementation of the present application, the method further includes: when the PDCP entity corresponds to multiple logical channels, the network device sends second indication information to the terminal device, wherein the second indication information is used for indicating a first logical channel used for transmitting data in the multiple logical channels or a second logical channel not used for transmitting data in the multiple logical channels.

Optionally, in an implementation of the present application, the at least one RB includes a Data. Radio Bearer (DRB) and/or a Signaling Radio Bearer (SRB).

It should be understood that interaction between the network device and the terminal device, and related characteristics and functions, etc., described by the network device, correspond to related characteristics and functions of the terminal device. Moreover, related contents have been described in detail in the above method 100, and will not be repeated here for the sake of brevity.

It should be understood that in various implementations of the present application, values of sequence numbers in the aforementioned processes do not indicate an order of execution, and the order of execution of various processes should be determined by their functions and internal logics, and should not constitute any limitation on implementation processes of implementations of the present application.

The methods for transmitting data according to the implementations of the present application have been described above in detail. Devices for transmitting data according to implementations of the present application will be described below with reference to FIGS. 5 to 8. Technical features described in the method implementations are applicable to the following device implementation.

FIG. 5 is a schematic block diagram of a terminal device 300 according to an implementation of the present application. As shown in FIG. 5, the terminal device 300 includes a receiving unit 310 and a processing unit 320.

The first receiving unit 310 is used for receiving first indication information sent by a network device, wherein the first indication information is used for indicating whether a data duplication and transmission function is enabled for each Radio Bearer (RB) in at least one RB.

The sending unit 320 is used for sending data to the network device according to the first indication information.

Therefore, the terminal device of the implementation of the present application is beneficial to improving flexibility of data transmission.

Optionally, in an implementation of the present application, the first receiving unit 210 is specifically used for receiving the first indication information sent by the network device through a Media Access Control (MAC) Control Element (CE).

Optionally, in an implementation of the present application, the first indication information carries an identification of the each RB, wherein the identification of the each RB is used for indicating that the data duplication and transmission function is enabled for a corresponding RB, or the identification of the each RB is used for indicating that the data duplication and transmission function is stopped to be used for a corresponding RB.

Optionally, in an implementation of the present application, the first indication information is a bit map, wherein each bit in the bit map corresponds one-to-one with the each RB, and a value of the each bit indicates whether a data duplication and transmission function is enabled for a corresponding RB.

Optionally, in an implementation of the present application, the sending unit 320 is specifically used for determining that the data duplication and transmission function is enabled for a first RB in the at least one RB according to the first indication information; and sending duplicated data to the network device through multiple logical channels corresponding to a Packet Data Convergence Protocol (PDCP) entity corresponding to the first RB.

Optionally, in an implementation of the present application, the terminal device 300 further includes: a second receiving unit, used for, when the PDCP entity corresponds to only one logical channel, receiving second indication information, wherein the second indication information is used for indicating at least one other logical channel for transmitting the duplicated data.

Optionally, in an implementation of the present application, the sending unit 320 is specifically used for sending non-duplicated data to the network device through a logical channel corresponding to a PDCP entity corresponding to the first RB.

Optionally, in an implementation of the present application, the sending unit 320 is specifically used for: when the PDCP entity corresponds to multiple logical channels, receiving second indication information sent by the network device, wherein the second indication information is used for indicating a first logical channel used for transmitting data in the multiple logical channels; and sending the non-duplicated data to the network device through the first logical channel.

Optionally, in an implementation of the present application, the sending unit 320 is specifically used for: when the PDCP entity corresponds to multiple logical channels, receiving second indication information sent by the network device, wherein the second indication information is used for indicating a first logical channel that is not used to transmit data in the multiple logical channels; and sending non-duplicated data to the network device through a second logical channel other than the first logical channel in the multiple logical channels.

Optionally, in an implementation of the present application, the at least one RB includes a Data Radio Bearer (DRB) and/or a Signaling Radio Bearer (SRB).

It should be understood that the terminal device 300 according to the implementation of the present application may correspond to the terminal device in the method implementation of the present application, and the above operations and/or functions and other operations and/or functions of various units in the terminal device 300 are respectively for realizing corresponding processes of the terminal device in the method in FIG. 3, and will not be repeated here for brevity.

FIG. 6 is a schematic block diagram of a network device 400 according to an implementation of the present application. As shown in FIG. 6, the terminal device 400 includes a determination module 410 and a communication module 420.

The first sending unit 410 is used for sending first indication information to a terminal device, wherein the first indication information is used for indicating whether a data duplication and transmission function is enabled for each Radio Bearer (RB) in at least one RB.

The receiving unit 420 is used for receiving data sent by the terminal device through the at least one RB.

Therefore, the network device of the implementation of the present application is beneficial to improving flexibility of data transmission.

Optionally, in an implementation of the present application, the first sending unit 410 is specifically used for sending the first indication information to the terminal device through a Media Access Control (MAC) Control Element (CE).

Optionally, in an implementation of the present application, the first indication information carries an identification of the each RB, wherein the identification of the each RB is used for indicating that the data duplication and transmission function is enabled for a corresponding RB, or the identification of the each RB is used for indicating that the data duplication and transmission function is stopped to be used for a corresponding RB.

Optionally, in an implementation of the present application, the first indication information is a bit map, wherein each bit in the bit map corresponds one-to-one with the each RB, and a value of the each bit indicates whether a data duplication and transmission function is enabled for a corresponding RB.

Optionally, in an implementation of the present application, the first indication information is used for indicating that the data duplication and transmission function is enabled for a first RB in the at least one RB, and the receiving unit is specifically used for receiving duplicated data sent by the terminal device through multiple logical channels corresponding to a Packet Data Convergence Protocol (PDCP) entity corresponding to the first RB.

Optionally, in an implementation of the present application, the network device 400 further includes: a second sending unit, used for, when the PDCP entity corresponds to only one logical channel, sending second indication information to the terminal device, wherein the second indication information is used for indicating at least one other logical channel used for transmitting the duplicated data.

Optionally, in an implementation of the present application, the receiving unit 420 is specifically used for receiving non-duplicated data sent by the terminal device through a logical channel corresponding to a PDCP entity corresponding to the first RB.

Optionally, in an implementation of the present application, the network device 400 further includes: a second sending unit, used for, when the PDCP entity corresponds to multiple logical channels, sending second indication information to the terminal device, wherein the second indication information is used for indicating a first logical channel used for transmitting data in the multiple logical channels or a second logical channel not used for transmitting data in the multiple logical channels.

Optionally, in an implementation of the present application, the at least one RB includes a Data Radio Bearer (DRB) and/or a Signaling Radio Bearer (SRB).

It should be understood that the network device 400 according to the implementation of the present application may correspond to the network device in the method implementation of the present application, and the above operations and/or functions and other operations and/or functions of various units in the network device 400 are respectively for realizing corresponding processes of the network device in the method in FIG. 4, and will not be repeated here for the sake of brevity.

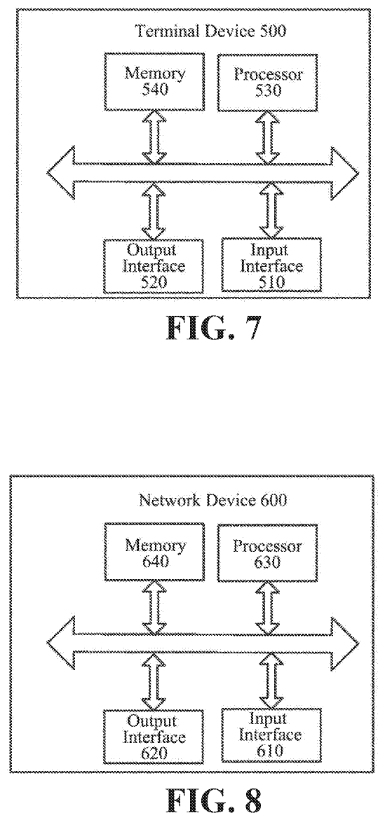

As shown in FIG. 7, an implementation of the present application also provides a terminal device 500, which may be the terminal device 300 in FIG. 5 and is able to be used for performing contents of the method 100 corresponding to the terminal device in FIG. 3. The terminal device 500 includes an input interface 510, an output interface 520, a processor 530, and a memory 540. The input interface 510, the output interface 520, the processor 530, and the memory 540 may be connected through a bus system. The memory 540 is used for storing programs, instructions, or codes. The processor 530 is used for executing the programs, instructions, or codes in the memory 540 to control the input interface 510 to receive signals, to control the output interface 520 to send signals, and to complete the operations in the foregoing method implementations.

Therefore, the terminal device of the implementation of the present application is beneficial to improving flexibility of data transmission.

It should be understood that in the implementation of the present application, the processor 530 may be a Central Processing Unit (CPU), or the processor 530 may be another general purpose processor, a digital signal processor, an application specific integrated circuit, a Field programmable gate array or another programmable logic device, a discrete gate or transistor logic device, a discrete hardware component, etc. The general purpose processor may be a microprocessor or the processor may be any conventional processor or the like.

The memory 540 may include a read-only memory and a random access memory, and provide instructions and data to the processor 530. A portion of memory 540 may include a non-volatile random access memory. For example, the memory 540 may also store type information of a device.

In implementation processes, various acts of the methods described above may be accomplished by integrated logic circuits of hardware or instructions in the form of software in the processor 530. The acts of the method disclosed in connection with the implementations of the present application may be directly embodied to be accomplished by an execution of the hardware processor or by the combination of hardware and software modules in the processor. The software modules may be located in a storage medium commonly used in the art, such as a random access memory, flash memory, read-only memory, programmable read-only memory or electrically erasable programmable memory, or register. The storage medium is located in the memory 540, and the processor 530 reads the information in the memory 540, and accomplishes the contents of the above method in combination with its hardware. In order to avoid repetition, it will not be described in detail here.

In a specific implementation, the first receiving unit and the second receiving unit in the terminal device 300 may be implemented by the input interface 510 in FIG. 7, and the sending unit of the terminal device 300 may be implemented by the output interface 520 in FIG. 7.

As shown in FIG. 8, an implementation of the present application also provides a network device 600, which may be the network device 400 in FIG. 6, and is able to be used for performing contents of the method 200 corresponding to the network device in FIG. 4. The network device 600 includes an input interface 610, an output interface 620, a processor 630, and a memory 640. The input interface 610, the output interface 620, the processor 630, and the memory 640 may be connected through a bus system. The memory 640 is used for storing programs, instructions, or codes. The processor 630 is used for executing the programs, instructions, or codes in the memory 640 to control the input interface 610 to receive signals, to control the output interface 620 to send signals, and to complete the operations in the foregoing method implementations.

Therefore, the network device of the implementation of the present application is beneficial to improving flexibility of data transmission.

It should be understood that in the implementation of the present application, the processor 630 may be a Central Processing Unit (CPU), or the processor 630 may be another general purpose processor, a digital signal processor, an application specific integrated circuit, a Field programmable gate array or another programmable logic device, a discrete gate or transistor logic device, a discrete hardware component, etc. The general purpose processor may be a microprocessor or the processor may be any conventional processor or the like.

The memory 640 may include a read-only memory and a random access memory, and provide instructions and data to the processor 630. A portion of memory 640 may include a non-volatile random access memory. For example, the memory 640 may also store type information of a device.

In implementation processes, various acts of the methods described above may be accomplished by integrated logic circuits of hardware or instructions in the form of software in the processor 630. The acts of the method disclosed in connection with the implementations of the present application may be directly embodied to be accomplished by an execution of the hardware processor or by the combination of hardware and software modules in the processor. The software modules may be located in a storage medium commonly used in the art, such as a random access memory, a flash memory, read-only memory, a programmable read-only memory or an electrically erasable programmable memory, or a register. The storage medium is located in the memory 640, and the processor 630 reads the information in the memory 640, and accomplishes the contents of the above method in combination with its hardware. In order to avoid repetition, it will not be described in detail here.

In a specific implementation, the first sending unit and the second sending unit in the network device 400 may be implemented by the output interface 620 in FIG. 8, and the receiving unit in the network device 400 may be implemented by the input interface 610 in FIG. 8.

Those of ordinary skill in the art will recognize that the example units and algorithm acts described in connection with the implementations disclosed herein may be implemented in electronic hardware, or a combination of computer software and electronic hardware. Whether these functions are implemented in hardware or software depends on a specific application and design constraint of the technical solution. Skilled in the art may use different manners to realize the described functions for each particular application, but such realization should not be considered to be beyond the scope of the present application.

Those skilled in the art may clearly understand that for convenience and conciseness of description, the specific working process of the system, device and unit described above may refer to the corresponding process in the aforementioned implementations of methods, and details are not described herein again.

In several implementations provided by the present application, it should be understood that the disclosed system, apparatus and method may be implemented in other ways. For example, the apparatus implementation described above is only illustrative, for example, the division of the unit is only a logical function division, and there may be other ways of division in actual implementation, for example, multiple units or components may be combined or integrated into another system, or some features may be ignored or not executed. On the other hand, the mutual coupling or direct coupling or communication connection shown or discussed may be indirect coupling or communication connection through some interfaces, devices or units, and may be in electrical, mechanical or other forms.

The unit described as a separate component may or may not be physically separated, and the component shown as a unit may or may not be a physical unit, i.e., may be located in one place or may be distributed over multiple network units. Some or all of the units may be selected according to practical needs to achieve a purpose of the solution of the implementations.

In addition, various functional units in various implementations of the present application may be integrated in one processing unit, or various units may be physically present separately, or two or more units may be integrated in one unit.

The functions may be stored in a computer readable storage medium if implemented in a form of software functional units and sold or used as a separate product. Based on this understanding, the technical solution of the present application, in essence, or the part contributing to the existing art, or the part of the technical solution, may be embodied in the form of a software product stored in a storage medium, including several instructions for causing a computer device (which may be a personal computer, a server, or a network device, etc.) to perform all or part of the acts of various implementations of the present application. The aforementioned storage medium includes various media capable of storing program codes, such as a U disk, a mobile hard disk, a read-only memory (ROM), a random access memory (RAM), a magnetic disk, or an optical disk.

The foregoing are merely example implementations of the present application, but the protection scope of the present application is not limited thereto. Any person skilled in the art may easily conceive variations or substitutions within the technical scope disclosed by the present application, which should be included within the protection scope of the present application. Therefore, the protection scope of the present application shall be the protection scope defined by the claims.

1. A method for transmitting data, comprising:
receiving, by a terminal device, first indication information sent by a network device, wherein the first indication information is used for indicating whether a data duplication and transmission function is enabled for each Radio Bearer (RB) in at least one RB; and
sending, by the terminal device, data to the network device according to the first indication information.

2. The method of claim 1, wherein receiving, by the terminal device, the first indication information sent by the network device comprises:
receiving, by the terminal device, the first indication information sent by the network device through a Media Access Control (MAC) Control Element (CE).

3. The method of claim 1, wherein the first indication information carries an identification of the each RB, wherein the identification of the each RB is used for indicating that the data duplication and transmission function is enabled for a corresponding RB, or the identification of the each RB is used for indicating that the data duplication and transmission function is stopped to be used for a corresponding RB.

4. The method of claim 1, wherein the first indication information is a bit map, each bit in the bit map corresponds one-to-one with the each RB, and a value of the each bit indicates whether the data duplication and transmission function is enabled for a corresponding RB.

5. The method of claim 1, wherein sending, by the terminal device, the data to the network device according to the first indication information comprises:
determining, by the terminal device, that the data duplication and transmission function is enabled for a first RB of the at least one RB according to the first indication information; and
sending, by the terminal device, duplicated data to the network device through a plurality of logical channels corresponding to a Packet Data Convergence Protocol (PDCP) entity corresponding to the first RB.

6. The method of claim 5, wherein the method further comprises:
before the terminal device sends the duplicates data to the network device through the plurality of logical channels corresponding to the PDCP entity corresponding to the first RB,
when the PDCP entity corresponds to only one logical channel, receiving, by the terminal device, second indication information, wherein the second indication information is used for indicating at least one other logical channel used for transmitting the duplicated data.

7. The method of claim 1, wherein sending, by the terminal device, the data to the network device according to the first indication information comprises:
determining, by the terminal device, that the data duplication and transmission function is stopped to be used for a first RB of the at least one RB according to the first indication information; and
sending, by the terminal device, non-duplicated data to the network device through a logical channel corresponding to a Packet Data Convergence Protocol (PDCP) entity corresponding to the first RB.

8. The method of claim 7, wherein sending, by the terminal device, the non-duplicated data to the network device through the logical channel corresponding to the PDCP entity corresponding to the first RB, comprises:
when the PDCP entity corresponds to a plurality of logical channels, receiving, by the terminal device, second indication information sent by the network device, wherein the second indication information is used for indicating a first logical channel used for transmitting data in the plurality of logical channels; and
sending, by the terminal device, the non-duplicated data to the network device through the first logical channel.

9. The method of claim 7, wherein sending, by the terminal device, the non-duplicated data to the network device through the logical channel corresponding to the PDCP entity corresponding to the first RB, comprises:
when the PDCP entity corresponds to a plurality of logical channels, receiving, by the terminal device, second indication information sent by the network device, wherein the second indication information is used for indicating a first logical channel not used for transmitting data in the plurality of logical channels; and
sending, by the terminal device, the non-duplicated data to the network device through a second logical channel except the first logical channel in the plurality of logical channels.

10. The method of claim 1, wherein the at least one RB comprises a Data Radio Bearer (DRB) and/or a Signaling Radio Bearer (SRB).

11-19. (canceled)

20. A terminal device, comprising: a memory, a processor, a first input interface, and a first output interface;
wherein, the memory is used for storing programs, instructions, or codes;
the processor is used for executing the programs, the instructions, or the codes to control the first input interface to receive signals, and to control the first output interface to send signals;
the first input interface is used for receiving first indication information sent by a network device, wherein the first indication information is used for indicating whether a data duplication and transmission function is enabled for each Radio Bearer (RB) in at least one RB; and
the first output interface is used for sending data to the network device according to the first indication information.

21. The terminal device of claim 20, wherein the first input interface is specifically used for:
receiving the first indication information sent by the network device through a Media Access Control (MAC) Control Element (CE).

22. The terminal device of claim 20, wherein the first indication information carries an identification of the each RB, wherein the identification of the each RB is used for indicating that the data duplication and transmission function is enabled for a corresponding RB, or the identification of the each RB is used for indicating that the data duplication and transmission function is stopped to be used for a corresponding RB.

23. The terminal device of claim 20, wherein the first indication information is a bit map, wherein each bit in the bit map corresponds one-to-one with the each RB, and a value of the each bit indicates whether the data duplication and transmission function is enabled for a corresponding RB.

24. The terminal device of claim 20, wherein the first output interface is specifically used for: when the data duplication and transmission function is enabled for a first RB of the at least one RB according to the first indication information; and
sending duplicated data to the network device through a plurality of logical channels corresponding to a Packet Data Convergence Protocol (PDCP) entity corresponding to the first RB.

25. The terminal device of claim 24, wherein the terminal device further comprises:
a second input interface, used for, when the PDCP entity corresponds to only one logical channel, receiving second indication information, wherein the second indication information is used for indicating at least one other logical channel used for transmitting the duplicated data.

26. The terminal device of claim 20, wherein the first output interface is specifically used for: sending non-duplicated data to the network device through a logical channel corresponding to a Packet Data Convergence Protocol (PDCP) entity corresponding to a first RB.

27. The terminal device of claim 26, wherein the first output interface is specifically used for:
when the PDCP entity corresponds to a plurality of logical channels, receiving second indication information sent by the network device, wherein the second indication information is used for indicating a first logical channel used for transmitting data in the plurality of logical channels; and
sending the non-duplicated data to the network device through the first logical channel.

28. The terminal device of claim 26, wherein the first output interface is specifically used for:
when the PDCP entity corresponds to a plurality of logical channels, receiving second indication information sent by the network device, wherein the second indication information is used for indicating a first logical channel not used for transmitting data in the plurality of logical channels; and
sending the non-duplicated data to the network device through a second logical channel except the first logical channel in the plurality of logical channels.

29. The terminal device of claim 20, wherein the at least one RB comprises a Data Radio Bearer (DRB) and/or a Signaling Radio Bearer (SRB).

30. A network device, comprising: a memory, a processor, an input interface, and an output interface;
wherein, the memory is used for storing programs, instructions, or codes;
the processor is used for executing the programs, the instructions, or the codes to control the input interface to receive signals, and to control the output interface to send signals;
the output interface is used for sending first indication information to a terminal device, wherein the first indication information is used for indicating whether a data duplication and transmission function is enabled for each Radio Bearer (RB) in at least one RB; and
the input interface is used for receiving data sent by the terminal device through the at least one RB.

31. The network device of claim 30, wherein the output interface is specifically used for:
sending the first indication information to the terminal device through a Media Access Control (MAC) Control Element (CE).

32. (canceled)

33. The network device of claim 30, wherein the first indication information is a bit map, wherein each bit in the bit map corresponds one-to-one with the each RB, and a value of the each bit indicates whether the data duplication and transmission function is enabled for a corresponding RB.

34-38. (canceled)
